(19) United States
(12) Patent Application Publication
(10) Pub. No.: US 2016/0174473 A1
(43) Pub. Date: Jun. 23, 2016

(54) GROUND COVER MATERIALS

(71) Applicant: NINE IP LIMITED, Auckland (NZ)

(72) Inventors: Jonathan Dallas TOYE, Auckland (NZ); Suzanne Elizabeth FOY, Auckland (NZ)

(21) Appl. No.: 14/910,322

(22) PCT Filed: Aug. 8, 2014
(86) PCT No.: PCT/NZ2014/000165

§ 371 Date: Feb. 5, 2016

(30) Foreign Application Priority Data
Aug. 8, 2013 (NZ) 614074
Sep. 12, 2013 (IB) PCT/IB2013/058488

(51) Int. Cl. A01G 13/00

(52) U.S. Cl. CPC A01G 13/0268

(57) ABSTRACT

The present invention relates to ground cover sheet materials and to ground cover sheets comprising such materials. The ground cover sheet material absorbs more solar radiation than it reflects in the UV range of about 280-400 nm, and reflects more solar radiation than it either transmits or absorbs in the visible range of about 400-700 nm and near infrared range of about 700-800 nm, and transmits at least part of solar radiation in the range about 800-2500 nm and at least part of solar radiation above about 2500 nm.

### FIELD OF THE INVENTION

The invention relates to ground cover sheet materials and to ground cover sheets comprising such materials.

### BACKGROUND TO THE INVENTION

Ground cover materials are used in agriculture for a number of purposes including weed suppression and/or soil warmth retention and/or moisture retention and/or for light reflecting.

Currently known important woven ground covers are as follows: black pigmented plastic ground cover; green pigmented plastic ground cover; and white pigmented plastic ground cover.

The black, woven plastic ground covers warm the soil more than other pigmented ground covers.

The green, woven plastic ground covers are used for aesthetics over other coloured pigmented ground covers.

Dark coloured pigmented woven plastic ground cover materials block light and are preferable for use in suppressing weeds. Black pigmented woven ground cover material is preferred for weed suppression.

The white pigmented woven plastic ground covers look to increase reflected light into the plant canopy.

White pigmented woven ground covers are produced from plastic polymer pigmented with the white titanium dioxide pigment.

Typically where a sheet is used primarily as a reflective ground cover for light enhancement in an orchard or vineyard for example, the sheet is rolled out in lengths onto the ground, and secured in place, beneath or between rows of trees, vines, or plants, to increase the amount of light to which the plants and in particular fruit are exposed by reflection of light from the sheet towards the fruit above.

The woven sheet may remain in place for some months, before being removed and reused in a subsequent growing season or on another crop in the same growing season, but in some cases may remain in place over multiple growing seasons as a permanent feature.

It is an object of the present invention to provide improved ground cover materials and ground cover sheets, or to at least provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In a first aspect the present invention broadly consists in a ground cover sheet material that absorbs more solar radiation than it reflects in the UV range of about 280-400 nm, and reflects more solar radiation than it either transmits or absorbs in the visible range of about 400-700 nm and near infrared range of about 700-800 nm, and transmits at least part of solar radiation in the range about 800-2500 nm and at least part of solar radiation above about 2500 nm.

In some embodiments, the material reflects at least about 50, 55, 60, or 65% of solar radiation in the infrared range of about 700-1000 nm.

In some embodiments, the material reflects at least about 40, 45, 50, 55, or 60% of solar radiation in the infrared range of about 1000-1500 nm.

In some embodiments, the material reflects at least about 30, 35, 40, 45, 50, or 55% of solar radiation in the infrared range of about 1500-2000 nm.

In some embodiments, the material reflects:
at least about 50, 55, 60, or 65% of solar radiation in the infrared range of about 700-1000 nm, and/or
at least about 40, 45, 50, 55, or 60% of solar radiation in the infrared range of about 1000-1500 nm, and/or
at least about 30, 35, 40, 45, 50, or 55% of solar radiation in the infrared range of about 1500-2000 nm.

In some embodiments the reflectance and transmittance of the material is shown in the table below:

| Wavelength nm | Reflectance | Transmittance |
|---|---|---|
| 280-420 | 0 to 35% | 0 to 15% |
| 421-700 | 40-95% | 5-60% |

In some embodiments the reflectance and transmittance of the material is shown in the table below:

| Wavelength nm | Reflectance | Transmittance |
|---|---|---|
| 280-420 | 0 to 30% | 0 to 15% |
| 421-700 | 40-95% | 5-50% |

In other embodiments the reflectance and transmittance of the material is shown in the table below:

| Wavelength nm | Reflectance | Transmittance |
|---|---|---|
| 280-420 | 0 to 15% | 0 to 15% |
| 421-700 | 40-95% | 5-50% |

In other embodiments a ground cover material of the invention has reflectance and transmittance as shown in the table below:

| Wavelength nm | Reflectance | Transmittance |
|---|---|---|
| 280-420 | 15-30% | 0-15% |
| 421-700 | 60-80% | 10-35% |

In some embodiments, the material comprises at least one main white UV reflecting pigment, and at least one UV absorbing co-pigment in an amount that decreases the reflectance at 280 nm-400 nm due to the main white pigment by increasing UV absorbance (i.e. in an amount that decreases the reflectance of the ground cover sheet material at 280 nm-400 nm compared to that material without the co-pigment due to increasing the UV absorbance of the material).

In some embodiments, the white main pigment is chosen from the group consisting of zirconium, strontium, barium, magnesium and calcium pigments.

In some embodiments the white main pigment is present in an amount of 5-50% by weight, or 5-30% by weight, or 5-25% by weight.

In some embodiments the main white pigment is selected from the group consisting of zirconium dioxide, magnesium zirconate, calcium zirconate, strontium zirconate, barium zirconate, zirconium silicate, calcium carbonate, barium sulphate, magnesium oxide, strontium carbonate, barium carbonate, dipotassium titanium trioxide, and potassium titanate, magnesium carbonate, aluminium oxide and aluminium hydroxide.

In some embodiments the main white pigment is selected from the group consisting of zirconium dioxide, barium sulphate and calcium carbonate. In some embodiments the zirconium dioxide, barium sulphate and calcium carbonate is provided in an amount of 12% to 30% by weight.

In some embodiments the zirconium dioxide, barium sulphate and calcium carbonate is in the form of particles of size 0.5-3 microns.

In some embodiments the main white pigment is barium sulphate or calcium carbonate. In some embodiments barium sulphate or calcium carbonate is provided in an amount of 12% to 30% by weight.

In some embodiments the barium sulphate or calcium carbonate is in the form of particles of size 0.5-3 microns.

In some embodiments the material comprises a polymer material with said white main pigment and said co-pigment present in the polymer material forming a polymer-pigment mixture, and the polymer-pigment mixture is mono-oriented or biaxially-oriented so that the main white pigment creates voids in the polymer for reflecting solar radiation.

In some embodiments the material comprises an organic UV absorbing pigment as a co-pigment.

In some embodiments the organic UV absorbing pigment is chosen from the group consisting of benzotriazole, cyanoacrylates, phenylacrylate, oxanilides, benzophenones, hydroxyphenyltriazines, hyrdoxyphenylbenzotriazole, tri and octyl methoxycinnamate, aminobenzoic acid, aminobenzoate and oxybenzone.

In some embodiments the organic UV absorbing pigment is added at a rate of 0.01% to 5% by weight.

In some embodiments the material comprises an inorganic clear or substantially clear UV absorbing pigment as a co-pigment.

In some embodiments the inorganic clear or substantially clear UV absorbing pigment is chosen from the group consisting of nano zinc oxide and cerium dioxide.

In some embodiments the inorganic clear UV absorbing pigment is added at a rate of 0.1% to 5% by weight.

In some embodiments the material comprises an inorganic white UV absorbing pigment as a co-pigment.

In some embodiments the inorganic white UV absorbing pigment is chosen from the group consisting of barium titanate, magnesium titanate, strontium titanate, neodymium titanate, tin oxide, titanium oxide, titanium dioxide, silica, alumina, zinc oxide, zinc sulphide, zinc sulphate, zirconium silicate and magnesium oxide.

In some embodiments the inorganic white UV absorbing pigment is added at a rate of 0.1% to 5% by weight.

In some embodiments the ground cover sheet is in the form of tape. In some embodiments the tape has a rectangular or square cross-section.

In some embodiments the ground cover sheet is woven from warp and weft tapes.

In some embodiments the warp tapes and the weft tapes have a rectangular or square cross-section.

In some embodiments the sheet material comprises a polymer material comprising polyethylene or polypropylene or a mixture thereof. In some embodiments the polymer material is high density Polyethylene (HDPE) or linear low density polyethylene (LLDPE) or a mixture of both.

In some embodiments the sheet material transmits at least 10%, 15%, 20% or 25% of solar radiation in the range about 800-2500 nm. In other embodiments the sheet material transmits between 10% and 70%, between 20% and 60%, or between 30% and 50% of solar radiation in the range about 800-2500 nm.

In a second aspect, the present invention broadly consists in a woven ground cover sheet material comprising:
at least one UV reflecting white main pigment,
at least one inorganic white UV absorbing pigment,
at least one inorganic clear or substantially clear (when used in plastic film) UV absorbing pigment, and
at least one organic UV absorbing pigment,
the UV absorbing pigments decreasing the reflectance in the UV (280 nm-400 nm) range due to the white main pigment by increasing UV absorbance.

In some embodiments the UV absorbing pigments decreases the surface reflectance in the UV (280 nm-400 nm) range. In some embodiments material comprises a polymer and the UV absorbing pigments decrease the internal reflectance within the polymer of the material, for example between pigment particles, and/or between micro voids formed in the polymer.

In a third aspect, the present invention broadly consists in a woven ground cover sheet material comprising:
at least one UV reflecting white main pigment,
at least one inorganic white UV absorbing pigment, and
at least one organic UV absorbing pigment,
the UV absorbing pigments decreasing the reflectance in the UV (280 nm-400 nm) range due to the white main pigment by increasing UV absorbance (i.e. the UV absorbing pigments decreasing the reflectance in the UV range of about 280 nm-400 nm of the ground cover sheet material compared to that same material without the UV absorbing pigments due to increasing the UV absorbance of the material).

In some embodiments the UV absorbing pigments decreases the surface reflectance in the UV (280 nm-400 nm) range. In some embodiments material comprises a polymer and the UV absorbing pigments decrease the internal reflectance within the polymer of the material, for example between pigment particles, and/or between micro voids formed in the polymer.

The material may comprise any suitable polyolefin such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA), ethylene methyl acrylate (EMA), polytetrafluoroethylene (PTFE) and rubber are useful for imparting elasticity and other properties. Polyesters and polystyrene, styrene-butadiene (SB), acrylonitrile-butadiene-styrene (ABS), styrene-acrylonitrile (SAN), polyethylene terephthalate (PET), polymethylmethacrylate (PMMA) and polycarbonate are useful for influencing radiation (reflecting, absorbing and transmission) properties and also other properties on the materials. Starch and other plant polymers are useful to increase biodegradability.

Alternatively the material may comprise in part or whole of paper, wood or cellulose fibre, starch based polymers, casein, latex or in any combination of the above and/or with petroleum derived plastic polymers. The polymer or polymer blend may incorporate agents such as one or more UV stabilisers or processing aids.

In some embodiments the ground cover sheet material is in the form of a tape or film which is between 10 and 150, 10 and 100, 20 and 90, 30 and 80 or 40 and 60 microns thick.

In another aspect the present invention provides a ground cover sheet material of any of the above embodiments in the form of a tape or film which is between 10 and 150, 10 and 100, 20 and 90, 30 and 80, 35 and 60, 35 and 55, or 40 and 60 microns thick.

In another aspect the present invention provides a ground cover sheet comprising a ground cover material of the present invention.

In another aspect the present invention provides a ground cover sheet comprising a ground cover sheet material of any of the present invention wherein said material forms at least 20%, 30%, 40%, 50%, 60%, 70%, 80%, or 90% of the surface area of the material, or said ground cover sheet consists substantially of a ground cover sheet material of the present invention.

Typically ground cover sheets of the invention will be laid out in lengths on the ground between or beneath rows of the crop being grown, which may be trees, vines, bushes etc, and the materials are referred to in the specification as “ground cover sheet”. It is possible however that the ground cover sheets may be suspended or positioned above the ground, for example in a vertical or angled position, to reflect the solar radiation onto the crop, for example on either side of the crop row, for example trees, and the expression “ground cover sheet” is intended to encompass sheets for such applications also.

Ground cover sheets of the invention may be in the form of a woven product, knitted product, or film.

The following is a description of the spectrophotometer system and measuring method used for measuring solar radiation reflectance and transmittance values quoted in this specification.

In this specification, diffuse reflectance and transmittance data has been measured of individual tapes of the relevant material which the ground cover comprises, opposed to the ground cover as a whole, unless otherwise stated. The method of measurement is described below.

The spectrophotometer system is based around a GSA/McPherson 2051 1 metre focal length monochromator fitted with a prism predisperser and also stray light filters. The light source is a current regulated tungsten halogen lamp. The bandwidth is adjustable up to 3 nm. The monochromatic beam from the monochromator is focused onto the sample or into the integrating sphere using off-axis parabolic mirrors. The integrating spheres are coated with pressed halon powder (PTFE powder). Halon powder is also used as a white reflectance reference material. The detector is usually a silicon photodiode connected to an electrometer amplifier and digital volt meter. The whole system is controlled using software written in LabVIEW. The detectors used can be photomultiplier tubes, silicon diodes or lead sulphide detectors.

### Diffuse Reflectance Sphere.

The diffuse reflectance was measured using an integrating sphere with an internal diameter of 75 mm with the sample tilted at an angle of 6° to the incident light (specular reflectance included). The reference sample is pressed halon powder and a black cone is used to correct for stray light. Up to four test samples are mounted on a pneumatic driven sample changer along with the white reference and black cone.

### Diffuse Transmittance Sphere

The diffuse transmittance was measured using an integrating sphere with an internal diameter of 120 mm and coated with pressed halon powder. The sample is mounted on one port and the incident light port is at an angle of 90° around the sphere. The sphere rotates by 90° in the horizontal plane to allow the focused incident light to enter the sphere through the incident light port or the incident light to be transmitted through the sample and enter the sphere. The detector is mounted at the top of the sphere.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

### Absorbance

Absorbance is calculated as a back calculation from the calculated transmittance and reflectance values.

The term “ground cover sheet material” as used in this specification and claims refers the materials that make up the ground cover sheet, compared to the term “ground cover sheet” which refers to the ground cover sheet as a whole, unless the context otherwise requires.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

Preferred embodiments of the invention will be further described by way of example only and with reference to the accompanying drawings, in which:

FIG. 1a is a schematic stylised plan view of a section of ground cover sheet of the invention, woven with warp and weft tapes;

FIG. 1b is schematic stylised plan view of a section of another ground cover sheet of the invention, woven with warp and weft tapes;

FIGS. 2a-2c are elevation views of woven ground cover sheet of the invention fixed to the ground between rows of trees or crops;

FIG. 3 is a schematic perspective view showing the typical defining dimensions of rectangular cross-section warp or weft tapes used to weave the ground cover sheets of the invention;

FIG. 4 is a graph illustrating diffuse transmittance of a ground cover material of the invention compared to a prior art black ground cover material and a prior art white ground cover material and an alternative prior art white;

FIG. 4B is a graph illustrating the diffuse transmittance of a ground cover material of the invention compared to three alternative whites also of the invention;

FIG. 5 is a graph illustrating diffuse absorbance of a ground cover material of the invention compared to a prior art black ground cover material and a two prior art white ground cover materials;

FIG. 6 is a graph illustrating diffuse reflectance of a ground cover material of the invention compared to a prior art black ground cover material and a prior art white ground cover material, and an alternative prior art white;

FIG. 7 is a graph illustrating the difference in mean daily soil temperature of a ground cover material of the invention compared to a prior art black ground cover material and a prior art white ground cover material;

FIG. 8 is a table of the diffuse transmittance of FIG. 4;

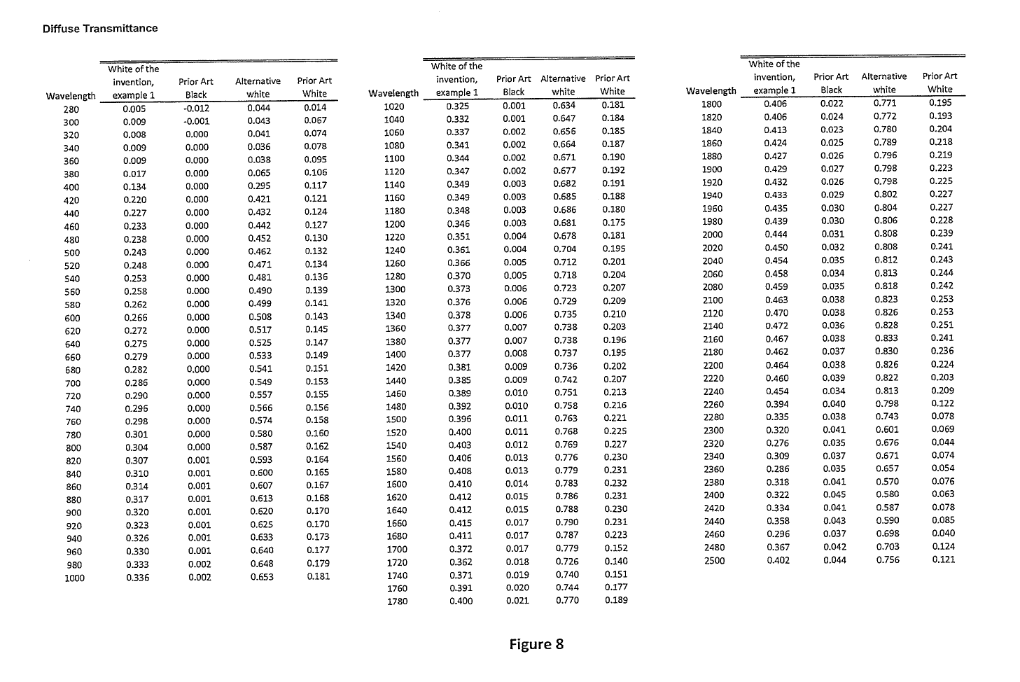

FIG. 9 is a table of the diffuse absorbance of FIG. 5; and

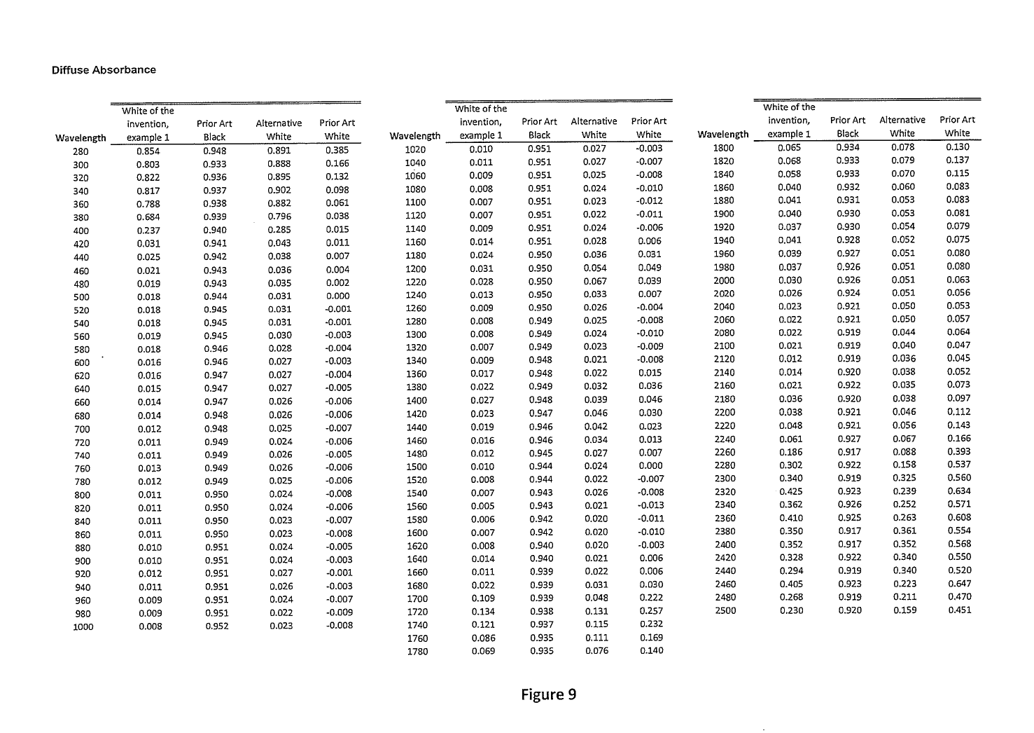

FIG. 10 is a table of the diffuse reflectance of FIG. 6.

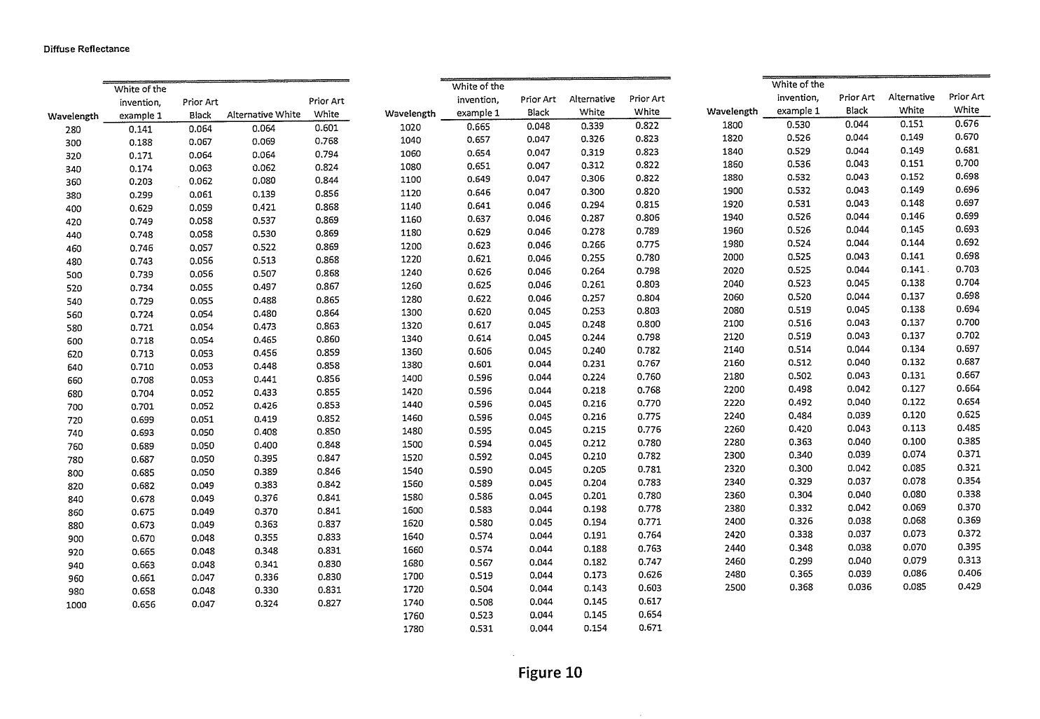

### DETAILED DESCRIPTION OF PREFERRED EMBODIMENTS

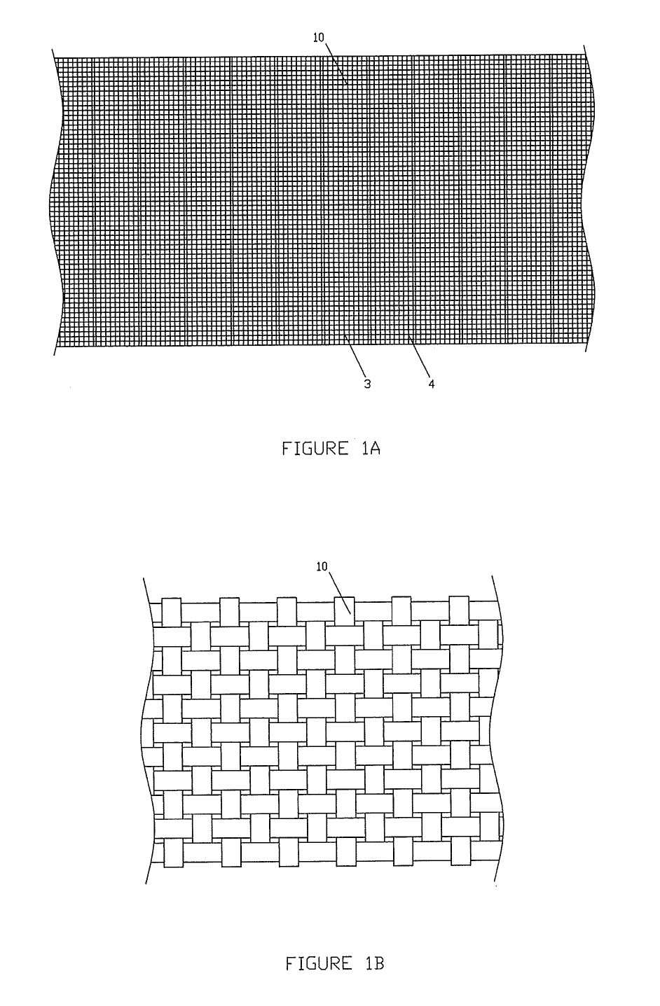

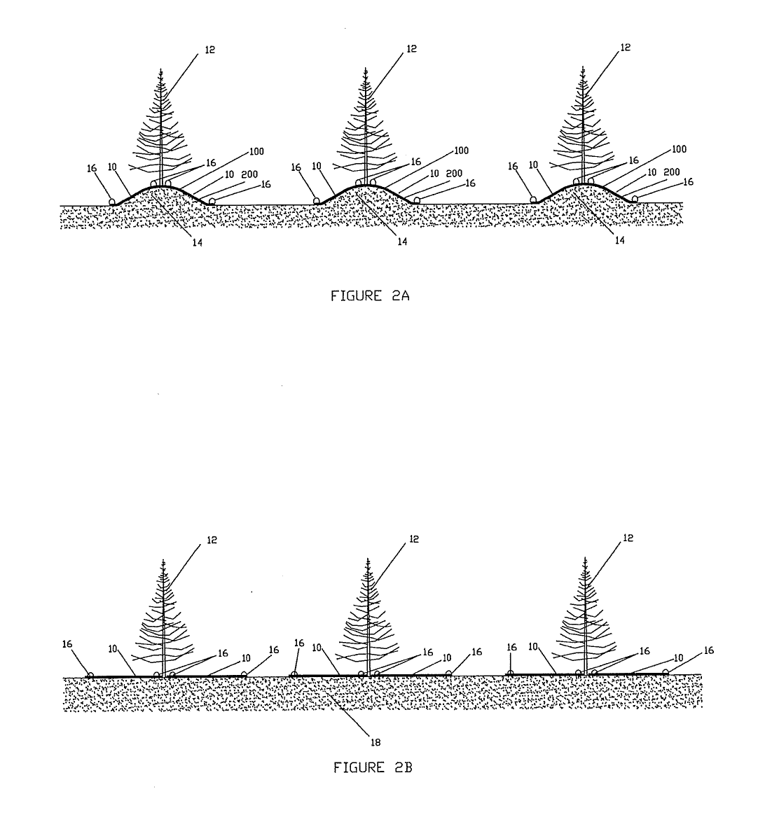

Figure is shows a section of ground cover sheet 10. The sheet 10 is preferably woven from flat warp 3 and weft 4 tapes of a plastics material. Preferably the sheeting does not have gaps, holes, slits or openings greater than 1.5 mm in or between the tapes so as to minimise unwanted plant growth through the sheets. In one construction there would be tape cramming (tape folding) between the tapes, to close out any gaps, as shown in FIG. 1b. In another construction there is gaps between the tapes so there is no tape cramming. The tapes may be formed by extruding a film material from a polymer resin and then cutting the film into tapes which are in turn used to weave the sheet, or by extruding individual tapes. In some embodiments the tapes may be stretched before cutting and being woven into the sheet. The tapes may be formed from a polymer containing pigments, inorganic and/or organic which give the ground cover material desired properties, such as desired light reflective, absorptive and/or transmission properties for example.

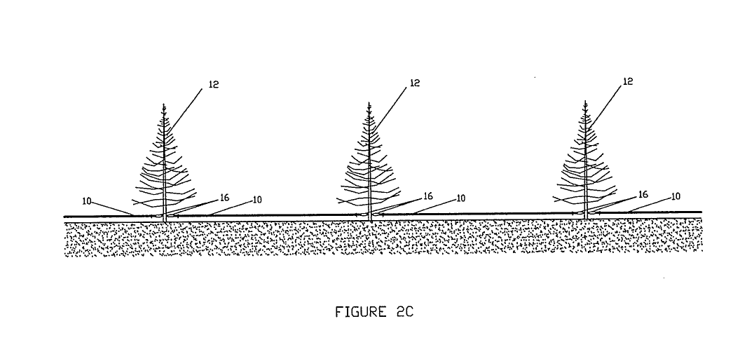

Typically the sheet has a greater length than width and is provided as a roll or in concertina folded form. Referring to FIGS. 2a and 2b, lengths of the ground cover sheet 10 can be fixed between or beneath rows of crops, for example fruit trees 12, in various ways depending on the primary function of the ground cover, for example weed suppression or soil warming. FIG. 2a shows lengths of ground cover sheet 10 laid on the ground underneath a tree. The sheet is preferably staked or stapled to the ground by staples or pegs hammered or pushed through the sheet and into the ground. The orchard trees 12 in this form are grown on rows of mounded soil 14, and the lengths of sheet 10 are fixed peripherally along each side into the ground by stakes or pegs 16. FIG. 2b shows a similar fixing configuration for lengths of ground cover sheet laid on flat ground soil 18. It will be appreciated that the ground cover sheets may be employed on any type of profile of ground surface, whether flat, mounded, sloped, undulating, contoured or a combination of these. In FIG. 2c, the ground cover sheet is suspended above the ground between two rows of trees.

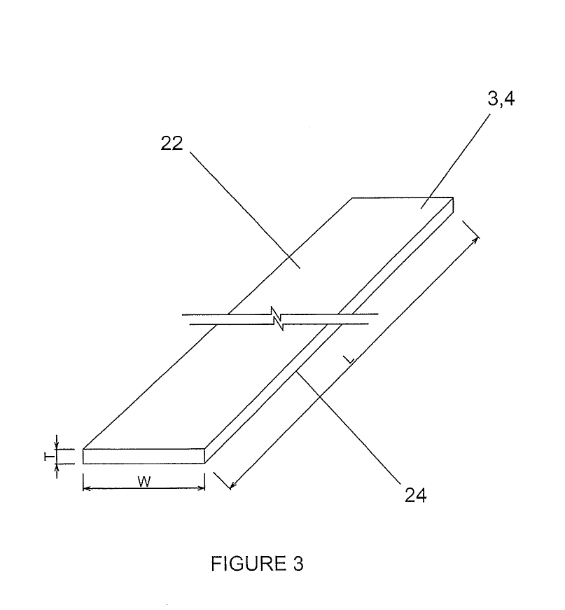

FIG. 3 shows dimensional profile and shape of substantially rectangular cross-section warp and/or weft tapes which may be used to weave the ground cover sheet, for the purpose of further explanation of the various embodiments of the ground cover material. The warp and/or weft tapes 3 and 4, have an indefinite length, designated by reference double-ended arrow L. The top and bottom surfaces 22 and 24 of the tape form the top and bottom surfaces of the ground cover sheet once woven. In this form the tapes are substantially rectangular in cross-section and have a width, designated by double-ended arrow W, and a thickness, designated by double-ended arrow T. It will be appreciated that the width and thickness of the tapes are substantially uniform along the length of the tape. In other forms the tapes may have different cross-section shapes, for example oval, round or square.

In a ground cover according to one aspect of the invention, the ground cover sheet material absorbs more solar radiation than it reflects in the UV (about 280-400 nm) range, and reflects more solar radiation than it either transmits or absorbs in the visible (about 400-700 nm) and near infrared (about 700-800 nm) ranges, and transmits at least part of solar radiation in the range about 800-2500 nm and at least part of solar radiation above about 2500 nm. Such a sheet material may provide reflection of solar radiation, in particular 400 to 700 nm, visible light, to increase the amount of light to which plants and fruit are exposed, but without increasing the amount of UV on the fruit or plants, which can be damaging to the plant and fruits. Also, UV absorption improves the longevity of the material by reducing the effects of degrading UV light on plastic polymers of the material. Prior art products that have high visible light reflectance and also relatively high UV reflectance have poor product life. Other prior art products that have high visible light reflection and high UV absorption do not have high levels of infrared reflection. The ground cover sheet materials of the invention may reflect more infrared radiation than the prior art, which can be beneficial in cooling soil in environments with too much soil warmth occurs from solar radiation. The ground sheet materials of the invention may also have low visible light transmission, thereby effective suppressing weed growth beneath the material. The ground cover sheet materials of the invention may provide the above advantages while being constructed from relatively thin material, enabling a relatively light weight product that is very effective.

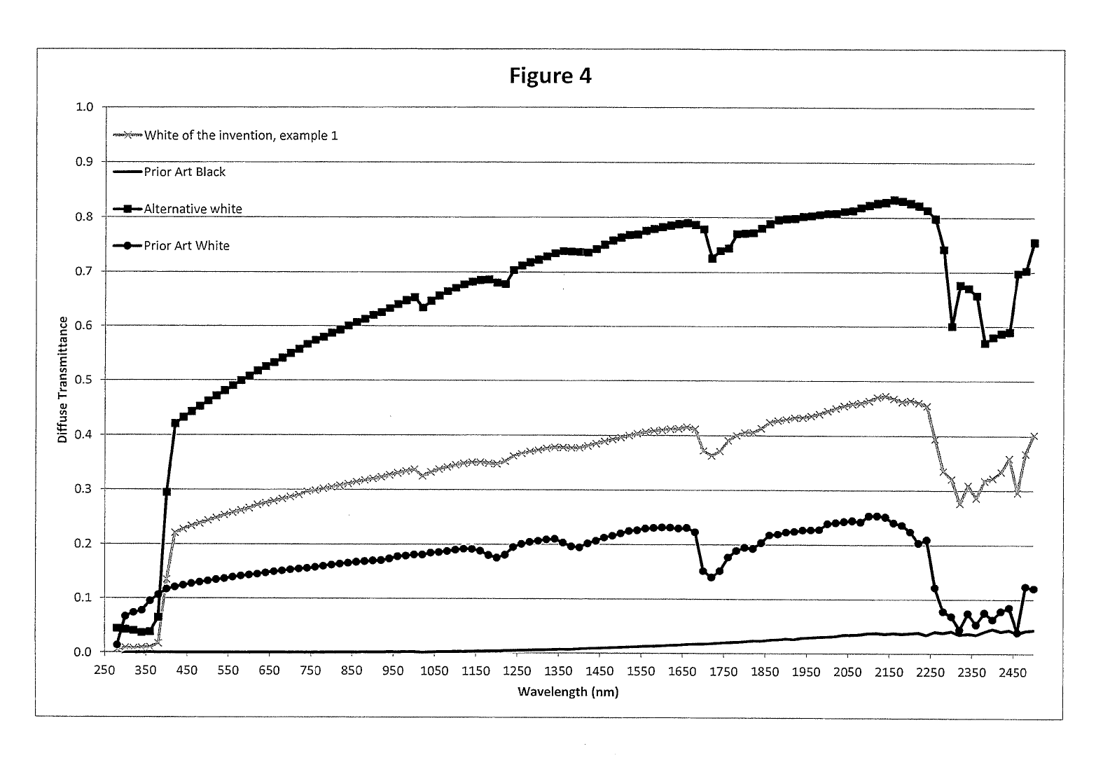

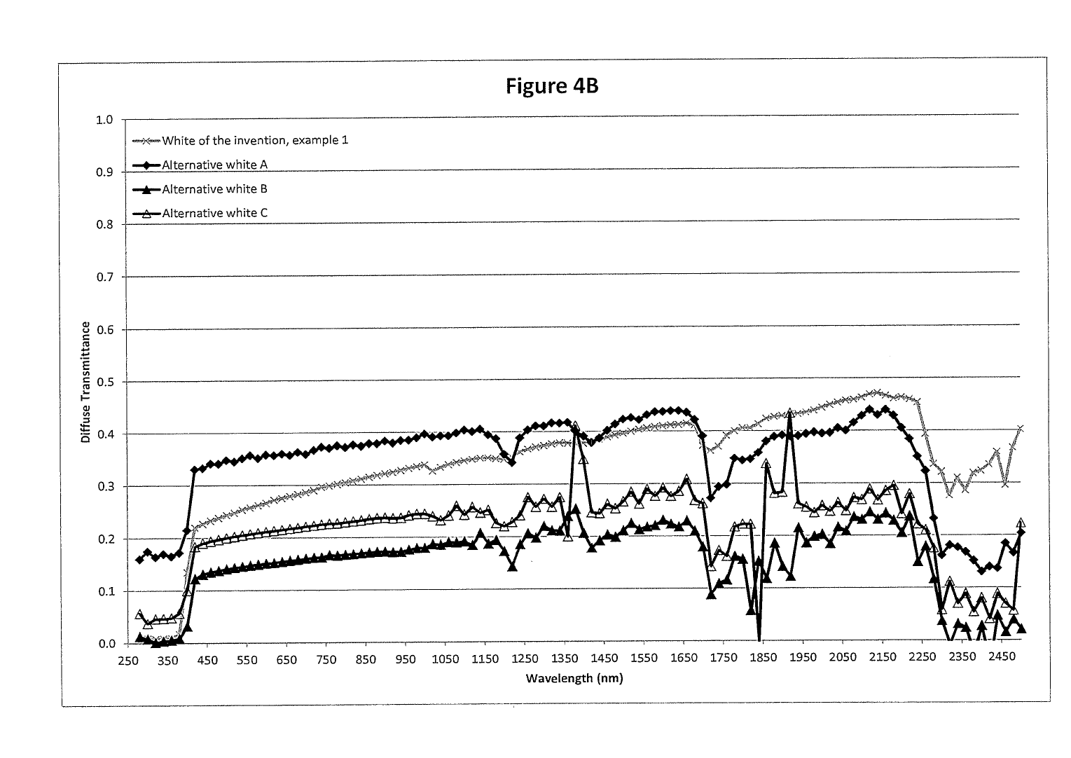

FIG. 4 is a graph illustrating diffuse transmittance of a ground cover material of the invention compared to a prior art black ground cover material and a prior art white ground cover material and an alternative prior art white. This graph shows the low UV transmittance of the white of the invention compared to both prior art whites and also the transmittance in the visible is relatively low compared to one alternative white which is important for weed suppression.

FIG. 4B is a graph illustrating the diffuse transmittance of a ground cover material of the invention compared to three alternative whites also of the invention. The graph demonstrates a range of different whites within the invention which achieve low UV transmittance of visible that is acceptable in terms of weed suppression, as well as good IR reflectance.

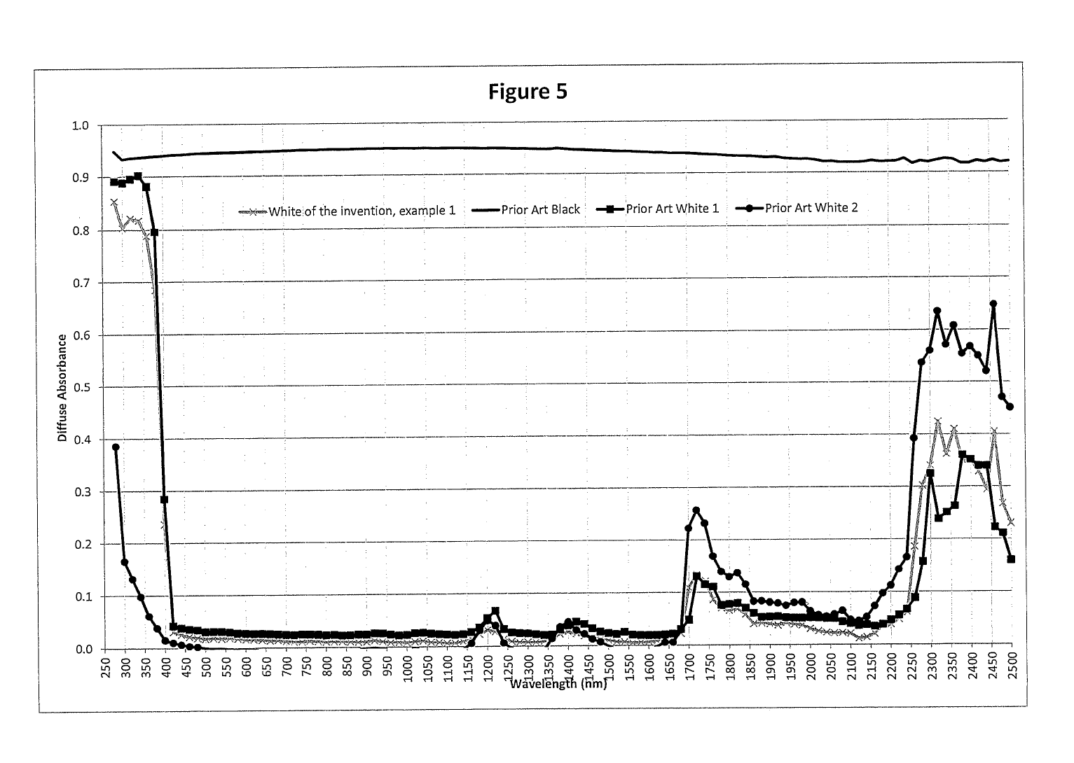

FIG. 5 is a graph illustrating diffuse absorbance of a ground cover material of the invention compared to a prior art black ground cover material and a two prior art white ground cover materials. This shows the white of the invention high absorbance in the UV region.

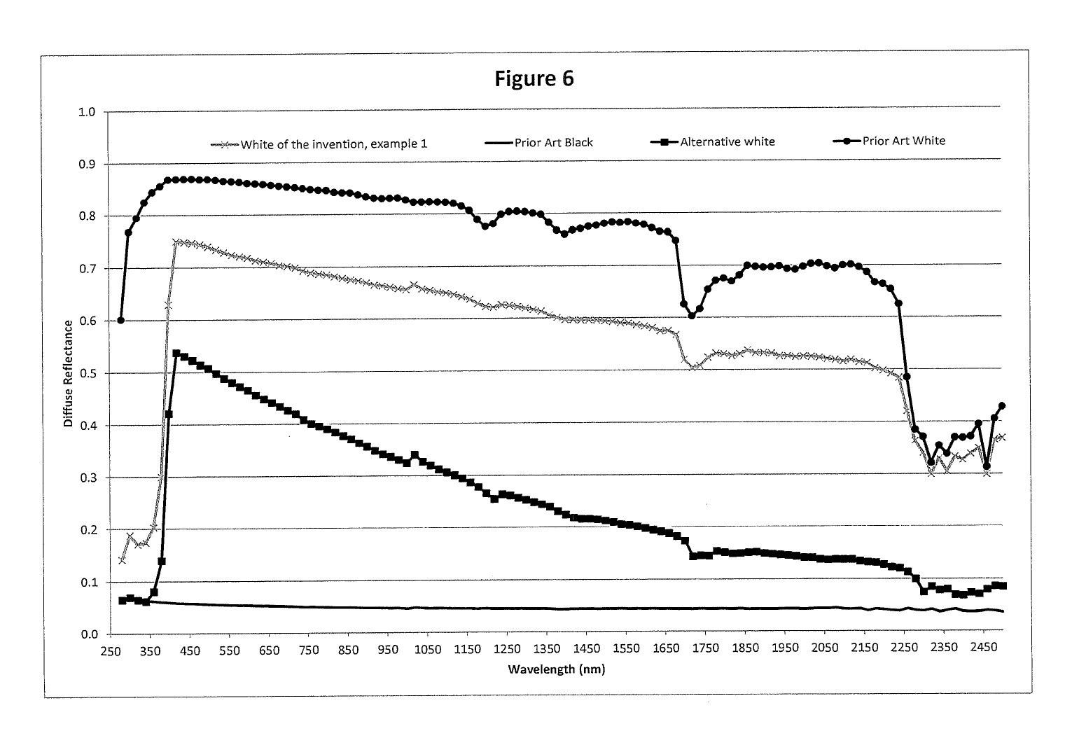

FIG. 6 is a graph illustrating diffuse reflectance of a ground cover material of the invention compared to a prior art black ground cover material and a prior art white ground cover material, and an alternative prior art white. This shows a high ratio of reflectance of visible light compared to UV, and also high reflectance of IR.

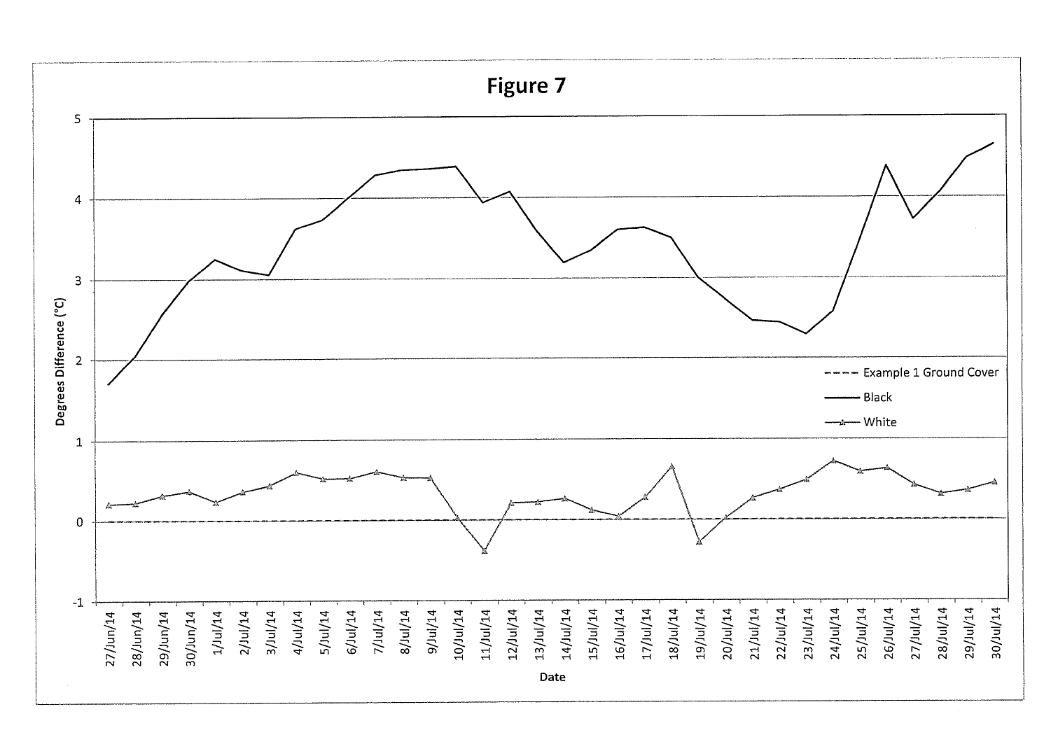

FIG. 7 is a graph illustrating the difference in mean daily soil temperature of a ground cover material of the invention compared to a prior art black ground cover material and a prior art white ground cover material. The white of the invention has lower temperatures consistently than the black or the prior art white.

To achieve desired reflectance and transmittance properties, the ground cover material preferably comprises a white pigment chosen from zirconium, strontium, barium, magnesium, and calcium pigments. This white pigment may be described as a main pigment. The main pigment may be present in an amount of 5 to 50% by weight, or 5 to 30% by weight, or 5 to 25% by weight.

More specifically, the white pigment may be chosen from the group consisting of Zirconium dioxide, magnesium zirconate, calcium zirconate, strontium zirconate, barium zirconate and zirconium silicate, calcium carbonate, barium sulpohate, magnesium oxide, strontium carbonate, barium carbonate, dipotassium titanium trioxide, and potassium titanate, magnesium carbonate, aluminium oxide and aluminium hydroxide and mixtures of these pigments are preferred white pigments. Especially preferred white pigments are zirconium dioxide, barium sulphate and calcium carbonate. In a preferred embodiment the main pigment is barium sulphate and/or calcium carbonate. In one embodiment, the main pigment is barium sulphate and/or calcium carbonate in an amount of 12-30% by weight.

In some embodiments the ground cover material comprises a mono-orientated or biaxially orientated reflective material comprising a polymer or polymers and at least one substantially white pigment, that when mixed with the polymer(s) to form a polymer/pigment mix, that when extruded and mono-orientated and/or biaxially-orientated, provides increased reflectivity relative to the same material without mono-orientation or biaxial-orientation of the polymer and pigment(s) mixture. The polymer/pigment mixture may be manufactured by treating a thick and wide plastic tape containing a pigment in a form allowing mono-orientation by stretching the tape to decrease its thickness and width and orientate the polymer(s) and pigment(s) mixture.

The effect of this orientation is marked where without the orientation the polymer/pigment mixture has a relatively low opaqueness (that is, low reflectivity of visible light) but on orientation the material is now thinner but the opaqueness (or reflectivity of visible light) is greatly increased.

Preferably the pigment that shows this opaqueness or reflectivity increase, when present in a polymer/pigment mixture that is mono-orientated and/or biaxially-orientated is a substantially white pigment, more preferably a metal salt or oxide. Most preferably the material is made from a polyolefin containing a white pigment, preferably barium sulphate and/or calcium carbonate that has been uniaxially orientated (mono-oriented) or biaxially orientated to create micro-void cells that assist with the development of the material's reflectance and transmittance properties. For many applications mono-orientation is preferred with tapes being stretched to a length of at least 5 times greater or more. Other white pigments that create micro voids when oriented are magnesium zirconate, calcium zirconate, strontium zirconate, barium zirconate and zirconium silicate.

The orientation of the polymer/pigment mixture also assists the development of thermic properties of the material to influence soil and air temperature.

A particularly preferred pigment for use in this aspect of the invention is barium sulphate or calcium carbonate, as a mineral obtained from mining or as a precipitate from manufacturing. The pigment is preferably processed to a fine micron size in the range 0.05 to 10 microns preferably 0.5-3 microns, most preferably 0.7-1.0 micron. Other useful white pigments for use in this aspect of the invention are listed above.

The creation of voids due to the orientation of the polymer/pigment combination is assisted by the type of polymer or polymers. The use of homopolymer polypropylene and/or random co-polymer of polypropylene and/or ethylene/propylene block co-polymer and/or co-monomer of ethylene and/or ethylene alpha-olefins and/or single site catalyst polyolefins and/or combinations of these polymers are particularly effective for the creation of the voids. High density polyethylene (HDPE) and/or polyethylene terephthalate (PET) may also be used for creating voids in the polymer-pigment mixture.

The production of polyolefin polymers based on what has been termed single site catalyst, or metallocene catalysts allow control over polymer architecture and are preferred polyolefins for orientation purposes.

In some embodiments the tapes are made on a cast film extruder. The film is then uniaxially oriented to reduce its thickness from about 200 microns to 75 microns, or 200 to 50 microns, or 200 to 25 microns. However, thin tapes, for example 25 micron, are less preferred as thin tapes will have a shortened useful life compared to thicker tapes. By orienting the tapes, the white pigment generates micro-voids in the tapes.

The development of this enhanced reflectivity of the polymer(s) and pigment(s) mixture is not limited to tapes. It can be also achieved by the mono-orientation of cast extruded film as a sheet. Additionally it can be also developed in blown film which is biaxially orientated and can also have greater orientation in one of the two orientation directions. This blown film can later be further orientated either mono-orientated or biaxially orientated.

To achieve desired reflectance and transmittance properties, a ground cover material according to the present invention comprises a white main pigment or pigments that are UV reflecting and preferably micro void generating by orientation as described above, plus one or more UV absorbing pigments.

In some embodiments the material comprises one or more inorganic white UV absorbing pigments. In some embodiments, the material comprises one or more clear or substantially clear (when used in plastic film) inorganic UV absorbing pigment. In some embodiments, the material comprises one or more organic UV absorbing pigments. In some embodiments, the material comprises a combination of one or more inorganic white UV absorbing pigments and one or more organic UV absorbing pigments. In some embodiments the material comprises a combination of one or more inorganic white UV absorbing pigments, one or more clear or substantially clear (when used in plastic film) inorganic UV absorbing pigments, and one or more organic UV absorbing pigments.

The UV absorbing pigments (inorganic white and/or organic and/or inorganic clear) are added in amounts that decrease the reflectance at 280-400 nm due to the main pigment(s). The UV absorbing pigment decreases the reflectance in the 280-400 nm range by increasing UV absorbance. For example, the material may comprise calcium carbonate or one of the other white UV reflecting pigments described above present in an amount of 5 to 50% by weight as the main pigment, and a UV absorbing pigment such as titanium dioxide present in an amount of 0.1% to 5% by weight. Increasing the absorbance in the UV range acts to improve the life of the polymer by protecting the polymer from UV light, and reduces plants exposure to excessive amounts of UV light that are treated by the ground cover material. One downside of the UV reflecting white pigment (with or without microvoids) is the reduction in the life of the polymers of the ground sheet material. This is due to the increase in UV light being reflected within the material. In order to extend the life of the polymers, UV absorbers are added to the main pigment/polymer mixture. This has the effect of absorbing any UV light before it can cause any free radicals produced during the interaction of the UV light waves and the polymer.

In some embodiments, the organic UV absorber(s) may be chosen from the group consisting of benzotriazole, cyanoacrylates, phenylacrylate, oxanilides, benzophenones, hydroxyphenyltriazines, hyrdoxyphenylbenzotriazole, tri and octyl methoxycinnamate, aminobenzoic acid, aminobenzoate and oxybenzone. Preferably organic UV absorbers are added at a rate of 0.01% to 5% by weight.

In some embodiments, the inorganic white UV absorber(s) may be chosen from the group consisting of barium titanate, magnesium titanate, strontium titanate, neodymium titanate, tin oxide, titanium oxide, zinc oxide, zinc sulphide, zinc sulphate, zirconium silicate and magnesium oxide. Preferably inorganic white UV absorbers are added at a rate of 0.1% to 5% by weight.

Example clear or substantially clear (when used in plastic film) inorganic UV absorbing pigments are nano zinc oxide and cerium dioxide. Preferably inorganic clear UV absorbers are added at a rate of 0.1% to 5% by weight.

### Example 1

This example describes a ground cover material of the present invention and a ground cover sheet comprising the material.

This example used a masterbatch in the form of thermoplastic granules containing 65% to 70% pigments of a combination of calcium carbonate, titanium dioxide, zinc oxide, hydroxyphenol benzotriazole and a first polymer. The tapes were 50 micron oriented polypropylene tapes that were woven into the ground cover sheet.

Warp and weft tapes of the ground cover were formed by first extruding a second polymer, polypropylene, and the masterbatch containing the pigments of the invention at an addition rate of 33% masterbatch to 67% polypropylene on a cast extrusion line to form a film of about 200 microns. The resulting film was quenched in a water bath and drawn through rollers under tension to form a sheet. The sheet was then transported under tension to a slitting device with a plurality of knives and slit into a plurality of narrow slit tapes. The tapes were then stretched and mono-axially oriented by passing the tapes through two sets of heated rollers on either side of an oven with an air temperature set at 140 to 160 degrees Celsius. The second set of rollers is colder than the first set, and the speed of the second set of rollers is 7 times the speed of the first set of rollers, this enables stretching and molecular chain orientation to increase the strength of the tapes compared to unstretched tapes. The process of orienting the tapes reduced the thickness of the tapes from 200 microns to 50 microns. The warp and weft tapes in turn were then used to weave the ground cover sheet.

FIGS. 4 to 6 are graphs comparing transmittance, absorbance and reflectance of the ground cover material of Example 1 compared to a prior art black ground cover material and a prior art white ground cover material.

### Field Trial 1

A field trial was conducted to determine the effect that the ground cover of example 1 would have on soil temperature compared to prior art black and another white ground cover. The trial was set up in Sunnyside Washington State, USA during summer to gain temperature data from beneath the ground covers being assessed.

All three covers had the same construction type and only varied in the colour/pigment chemistry of tapes used in their construction. More specifically, each was comprised of tapes 2.6 mm wide and 50 microns thick (about 2000 g/9000 m denier) woven from flat warp and weft tapes. The cover had no gaps, holes, slits or openings greater than 1 mm in or between the tapes so as to minimise unwanted plant growth between the cover. The tapes were crammed to create folding in the tapes to close any gaps. The fabric weight was 105 grams per square meter. The fabric construction was 10.4 tapes per inch in the warp direction and 10.4 tapes per inch in the weft direction.

The trial site was on a south facing slope free of trees or other plants that may otherwise intercept sunlight. Soil type was a sandy loam. The trial rows were set up with flat rows, 1 m wide and 9 m long.

The ground covers were installed during late spring. Temperature data loggers (Multitrip Data Logger, Temprecord) were installed at a depth of 20 cm beneath each ground cover treatment plot measuring soil temperature with data captured every 10 minutes. Raw data was converted into daily mean, maximum and minimum temperatures for each ground cover material type. Data is presented for the period 1 Jun. to 30 Jul. 2014.

Over the period of the trial, there were consistent differences in the mean, maximum and minimum soil temperatures beneath each type of weed suppression mat. The results of the mean temperatures are presented in Table 3 below. The ground cover of the invention produced significantly lower soil temperatures than the other art white ground cover. The prior art black ground cover had warmer temperatures as expected, and has been included for further comparison purposes. Data is presented in degrees celcius.

The results from the field trial are presented in Table 1.

| | Example 1 Ground | | |
|---|---|---|---|
| | Cover | Other White | Black |
| June Mean | 20.4 | 20.7 | 22.7 |
| Difference compared | 0 | 0.3 | 2.3 |
| to White | | | |
| July Mean | 22.2 | 22.5 | 25.8 |
| Difference compared | 0 | 0.3 | 3.6 |
| to White | | | |
| June-July Average | 22.0 | 22.3 | 25.4 |
| Difference compared | 0 | 0.3 | 3.4 |
| to White | | | |

As illustrated above, the ground cover sheet of the invention recorded the lowest mean temperature.

FIG. 7 illustrates the difference in mean daily soil temperature of the ground cover of example 1 compared to the prior art black ground cover material and the other white ground cover material of the trial above. In the figure, the ground cover material of the invention has been used as the baseline.

Various embodiments are described with reference to the Figures. The same reference numerals are used throughout to designate the same or similar components in various embodiments described.

The foregoing description of the invention includes preferred forms thereof. Modifications may be made thereto without departing from the scope of the invention as defined by the accompanying claims.

1. A ground cover sheet material that absorbs more solar radiation than it reflects in the UV range of about 280-400 nm, and reflects more solar radiation than it either transmits or absorbs in the visible range of about 400-700 nm and near infrared range of about 700-800 nm, and transmits at least part of solar radiation in the range about 800-2500 nm and at least part of solar radiation above about 2500 nm.

2. A ground cover as claimed in claim 1 wherein the material reflects at least about 50% of solar radiation in the infrared range of about 700-1000 nm.

3. A ground cover as claimed in claim 1 or 2 wherein the material reflects at least about 40% of solar radiation in the infrared range of about 1000-1500 nm.

4. A ground cover as claimed in any one of claims 1 to 3 wherein the material reflects at least about 30% of solar radiation in the infrared range of about 1500-2000 nm.

5. A ground cover as claimed in any one of claims 1 to 4 wherein the reflectance and transmittance of the material is shown in the table below:

| Wavelength nm | Reflectance | Transmittance |
|---|---|---|
| 280-420 | 0 to 35% | 0 to 15% |
| 421-700 | 40-95% | 5-60% |

6. A ground cover as claimed in any one of claims 1 to 4 wherein the reflectance and transmittance of the material is shown in the table below:

| Wavelength nm | Reflectance | Transmittance |
|---|---|---|
| 280-420 | 15-35% | 0-15% |
| 421-700 | 60-80% | 10-35% |

7. A ground cover as claimed in claim 1 wherein the reflectance and transmittance of the material is shown in the table below:

| Wavelength nm | Reflectance | Transmittance |
|---|---|---|
| 280-420 | 0 to 15% | 0 to 15% |
| 421-700 | 40-95% | 5-50% |

8. A ground cover sheet material as claimed in any one of claims 1 to 7 wherein the material comprises at least one main white UV reflecting pigment, and at least one UV absorbing co-pigment in an amount that decreases the reflectance of the ground cover sheet material at 280 nm-400 nm compared to that material without the co-pigment due to increasing the UV absorbance of the material.

9. A ground cover sheet material as claimed in claim 8 wherein the white main pigment is chosen from the group consisting of zirconium, strontium, barium, magnesium and calcium pigments.

10. A ground cover sheet material as claimed in claim 8 or 9 wherein the white main pigment is present in an amount of 5-50% by weight, or 5-30% by weight, or 5-25% by weight.

11. A ground cover sheet material as claimed in any one of claims to 10 wherein the main white pigment is selected from the group consisting of zirconium dioxide, magnesium zirconate, calcium zirconate, strontium zirconate, barium zirconate, zirconium silicate, calcium carbonate, barium sulphate, magnesium oxide, strontium carbonate, barium carbonate, dipotassium titanium trioxide, and potassium titanate, magnesium carbonate, aluminium oxide and aluminium hydroxide.

12. A ground cover sheet material as claimed in claim 11 wherein the main white pigment is selected from the group consisting of zirconium dioxide, barium sulphate and calcium carbonate.

13. A ground cover sheet material as claimed in claim 11 or 12 wherein the main white pigment is selected from the group consisting of barium sulphate and calcium carbonate.

14. A ground cover sheet material as claimed in claim 12 or 13 wherein the main white pigment is provided in an amount of 12% to 30% by weight.

15. A ground cover sheet material as claimed in any one of claim 12 or 14 wherein the main white pigment is in the form of particles of size 0.5-3 microns.

16. A ground cover sheet material as claimed in any one of claims 8 to 15 comprising a polymer material with said white main pigment and said co-pigment present in the polymer material forming a polymer-pigment mixture, and the polymer-pigment mixture is mono-oriented or biaxially-oriented so that the main white pigment creates voids in the polymer for reflecting solar radiation.

17. A ground cover sheet material as claimed in any one of claims 8 to 16 wherein the material comprises an organic UV absorbing pigment as a co-pigment.

18. A ground cover sheet material as claimed in claim 17 wherein the organic UV absorbing co-pigment is chosen from the group consisting of benzotriazole, cyanoacrylates, phenylacrylate, oxanilides, benzophenones, hydroxyphenyltriazines, hyrdoxyphenylbenzotriazole, tri and octyl methoxycinnamate, aminobenzoic acid, aminobenzoate and oxybenzone.

19. A ground cover sheet material as claimed in claim 18 wherein the organic UV absorbing pigment is added at a rate of 0.01% to 5% by weight.

20. A ground cover sheet material as claimed in any one of claims 8 to 19 wherein the material comprises an inorganic clear or substantially clear UV absorbing pigment as a co-pigment.

21. A ground cover sheet material as claimed in claim 20 wherein the inorganic clear or substantially clear UV absorbing pigment is chosen from the group consisting of nano zinc oxide and cerium dioxide.

22. A ground cover sheet material as claimed in claim 20 or 21 wherein the inorganic clear UV absorbing pigment is added at a rate of 0.1% to 5% by weight.

23. A ground cover sheet material as claimed in any one of claims 8 to 22 wherein the material comprises an inorganic white UV absorbing pigment as a co-pigment.

24. A ground cover sheet material as claimed in claim 23 wherein the inorganic white UV absorbing pigment is chosen from the group consisting of barium titanate, magnesium titanate, strontium titanate, neodymium titanate, tin oxide, titanium oxide, titanium dioxide, silica, alumina, zinc oxide, zinc sulphide, zinc sulphate, zirconium silicate and magnesium oxide.

25. A ground cover sheet material as claimed in claim 24 wherein the inorganic white UV absorbing pigment is added at a rate of 0.1% to 5% by weight.

26. A ground cover sheet material comprising:
at least one UV reflecting white main pigment,
at least one inorganic white UV absorbing pigment, and
at least one organic UV absorbing pigment,
the UV absorbing pigments decreasing the reflectance in the UV range of about 280 nm-400 nm of the ground cover sheet material compared to that same material without the UV absorbing pigments due to increasing the UV absorbance of the material.

27. A ground cover sheet material as claimed in claim 26 comprising least one inorganic clear or substantially clear UV absorbing pigment.

28. A ground cover sheet material as claimed in claim 26 or 27 wherein the UV absorbing pigments decrease the surface reflectance in the UV range of about 280 nm-400 nm.

29. A ground cover sheet material as claimed in any one of claims 26 to 28 comprising a polymer and the UV absorbing pigments decrease the internal reflectance within the polymer of the material.

30. A ground cover sheet material as claimed in any one of claims 26 to 29 wherein the white main pigment is chosen from the group consisting of zirconium, strontium, barium, magnesium and calcium pigments.

31. A ground cover sheet material as claimed in any one of claims 26 to 30 wherein the white main pigment is present in an amount of 5-50% by weight, or 5-30% by weight, or 5-25% by weight.

32. A ground cover sheet material as claimed in any one of claims 26 to 31 wherein the main white pigment is selected from the group consisting of zirconium dioxide, magnesium zirconate, calcium zirconate, strontium zirconate, barium zirconate, zirconium silicate, calcium carbonate, barium sulphate, magnesium oxide, strontium carbonate, barium carbonate, dipotassium titanium trioxide, and potassium titanate, magnesium carbonate, aluminium oxide and aluminium hydroxide.

33. A ground cover sheet material as claimed in claim 32 wherein the main white pigment is selected from the group consisting of zirconium dioxide, barium sulphate and calcium carbonate.

34. A ground cover sheet material as claimed in claim 33 wherein the main white pigment is selected from the group consisting of barium sulphate and calcium carbonate.

35. A ground cover sheet material as claimed in claim 33 or 34 wherein the main white pigment is provided in an amount of 12% to 30% by weight.

36. A ground cover sheet material as claimed in any one of claims 33 to 35 wherein the main white pigment is in the form of particles of size 0.5-3 microns.

37. A ground cover sheet material as claimed in any one of claims 26 to 36 comprising a polymer material with said pigments present in the polymer material forming a polymer-pigment mixture, and the polymer-pigment mixture is mono-oriented or biaxially-oriented so that the main white pigment creates voids in the polymer for reflecting solar radiation.

38. A ground cover sheet material as claimed in any one of claims 26 to 37 wherein the organic UV absorbing co-pigment is chosen from the group consisting of benzotriazole, cyanoacrylates, phenylacrylate, oxanilides, benzophenones, hydroxyphenyltriazines, hyrdoxyphenylbenzotriazole, tri and octyl methoxycinnamate, aminobenzoic acid, aminobenzoate and oxybenzone.

39. A ground cover sheet material as claimed in claim 38 wherein the organic UV absorbing pigment is added at a rate of 0.01% to 5% by weight.

40. A ground cover sheet material as claimed in claim 27 wherein the inorganic clear or substantially clear UV absorbing pigment is chosen from the group consisting of nano zinc oxide and cerium dioxide.

41. A ground cover sheet material as claimed in claim 40 wherein the inorganic clear UV absorbing pigment is added at a rate of 0.1% to 5% by weight.

42. A ground cover sheet material as claimed in any one of claims 26 to 41 wherein the inorganic white UV absorbing pigment is chosen from the group consisting of barium titanate, magnesium titanate, strontium titanate, neodymium titanate, tin oxide, titanium oxide, titanium dioxide, silica, alumina, zinc oxide, zinc sulphide, zinc sulphate, zirconium silicate and magnesium oxide.

43. A ground cover sheet material as claimed in claim 42 wherein the inorganic white UV absorbing pigment is added at a rate of 0.1% to 5% by weight.

44. A ground cover sheet material as claimed in any one of claims 1 to 43 wherein the ground cover sheet material is in the form of tape.

45. A ground cover sheet material as claimed in claim 44 wherein the tape has a rectangular or square cross-section.

46. A ground cover sheet material as claimed in any one of claims 1 to 45 wherein the material comprises a polymer material comprising polyethylene or polypropylene or a mixture thereof.

47. A ground cover sheet material as claimed in claim 46 wherein the polymer material is high density Polyethylene (HDPE) or linear low density polyethylene (LLDPE) or a mixture of both.

48. A ground cover sheet material as claimed in any preceding claim in the form of a tape or film which is between 10 and 150, 10 and 100, 20 and 90, 30 and 80, 35 and 60, 35 and 55, or 40 and 60 microns thick.

49. A ground cover sheet comprising a ground cover sheet material as claimed in any preceding claim.

50. A ground cover sheet as claimed in claim 49 wherein said material forms at least 20%, 30%, 40%, 50%, 60%, 70%, 80%, or 90% of the surface area of the material, or said ground cover sheet consists substantially of a ground cover sheet material as claimed in any preceding claim.

51. A ground cover sheet material as claimed in claim 49 or 50 wherein the ground cover sheet material is woven from warp and weft tapes.

52. A ground cover sheet material as claimed in claim 51 wherein the warp tapes and the weft tapes have a rectangular or square cross-section.
